(19) United States
(12) Patent Application Publication
(10) Pub. No.: US 2009/0165284 A1
(43) Pub. Date: Jul. 2, 2009

(54) BEARING MECHANISM MANUFACTURING METHOD, MOTOR AND STORAGE DISK DRIVE APPARATUS

(75) Inventors: Masato GOMYO, Kyoto (JP); Yoichi SEKII, Kyoto (JP); Hirokazu SHIRAI, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/337,767

(22) Filed: Dec. 18, 2008

(30) Foreign Application Priority Data
Dec. 27, 2007 (JP) 2007-335835

(51) Int. Cl. G11B 33/00; G11B 17/02

(52) U.S. Cl. 29/603.03; 360/99.08; G9B/17.002

(57) ABSTRACT

A method for manufacturing a bearing mechanism includes the steps of: (a) setting a position of an annular member relative to a center axis; (b) moving the annular member toward an opening of a sleeve housing through a shaft by pressing and elastically deforming a bottom portion of the sleeve housing; (c) releasing the pressing to restore the bottom portion to its original shape; and (d) fixing the annular member to the sleeve housing. Herein, the step (b) is performed by arranging the annular member within the sleeve housing, making one end portion of the shaft received in the annular member contact an inner bottom surface of the sleeve housing or with a thrust member disposed thereon, and making the annular member contact the shaft in a direction leading from the opening to the bottom portion of the sleeve housing.

### FIELD OF THE INVENTION

The present invention relates to a method for manufacturing a bearing mechanism used in a motor, which is preferably employed in a storage disk drive apparatus.

### BACKGROUND OF THE INVENTION

In a storage disk drive apparatus for driving an optical disk, a magnetic disk or the like, demands for high storage density and high disk rotation speed becomes stronger year by year. In order to meet these demands, a spindle motor as a driving power source needs to show a prolonged lifespan, increased reliability, reduced noise generation, increased vibration accuracy and other properties. For example, a dynamic fluid pressure bearing having lubricant filled in a radial gap and a thrust gap is often employed in a recently available ramp-loading type storage disk drive apparatus for driving a magnetic disk. In such a storage disk drive apparatus, the radial gap and the thrust gap need to be set smaller in order to avoid problems such as a disk tilting that causes the disk to contact a ramp member. In this regard, if the radial gap is set smaller, the torque loss in the bearing becomes greater, which is undesirable in a mobile application. For that reason, it is important to increase the accuracy of the thrust gap.

In the meantime, there have been proposed various kinds of pivot bearings through which a shaft is brought into contact with and rotatably supported by a thrust member provided on the inner bottom surface of a sleeve housing. In case where the pivot bearings are applied to a spindle motor having a dynamic fluid pressure bearing, high accuracy is required in the gap that allows the shaft to move in an axial direction (namely, the axial gap).

Particularly, when the pivot bearings are used in a ramp-loading type storage disk drive apparatus in which a head portion is supported by a ramp member during stoppage of a disk, a cost-effective bearing assembling method that assures increased accuracy of the axial gap is required in order to prevent contact between the ramp member and the storage disk.

### SUMMARY OF THE INVENTION

In view of the above, in accordance with one aspect of the present invention, there is provided a method for manufacturing a bearing mechanism including the steps of: (a) setting a position of an annular member relative to a center axis by arranging the annular member within a substantially cylindrical bottom-closed sleeve housing, bringing one end portion of a shaft received in the annular member into contact with an inner bottom surface of the sleeve housing or with a thrust member disposed on the inner bottom surface, and bringing the annular member into contact with the shaft in a direction leading from an opening of the sleeve housing to a bottom portion of the sleeve housing; (b) moving the annular member toward the opening of the sleeve housing through the shaft by externally pressing and elastically deforming the bottom portion of the sleeve housing; (c) releasing the pressing of the bottom portion of the sleeve housing to restore the bottom portion to its original shape; and (d) fixing the annular member to the sleeve housing.

Further, in accordance with another aspect of the present invention, there is provided a method for manufacturing a bearing mechanism including the steps of: a) fixing an annular member to a substantially cylindrical bottom-closed sleeve housing while allowing the annular member and a shaft received in the annular member to be brought into contact with each other in a direction leading from an opening of the sleeve housing to a bottom portion of the sleeve housing by arranging the annular member within the sleeve housing and bringing one end portion of the shaft into contact with an inner bottom surface of the sleeve housing or with a thrust member disposed on the inner bottom surface; and b) moving at least a central portion of the bottom portion away from the shaft by radially inwardly pressing an outer surface of a deformation target portion of the sleeve housing positioned axially between the inner bottom surface of the sleeve housing and the end surface of the annular member facing the inner bottom surface to perform a plastic deformation of the deformation target portion

With the present invention, it is possible to easily and accurately form the gap that allows the shaft to move along the center axis thereof. It is also possible to slidably fix the annular member with ease while preventing occurrence of stress concentration during elastic deformation.

Furthermore, the gap that allows the shaft to move along the center axis thereof can be easily formed by directly deforming the sleeve housing. Further, it is possible to more reliably prevent the plastic deformation from affecting the inner diameter of the sleeve. In addition, it is possible to perform the plastic deformation uniformly in the circumferential direction while preventing occurrence of stress concentration.

### BRIEF DESCRIPTION OF THE INVENTION

The above features of the present invention will become apparent from the following description of preferred embodiments, given in conjunction with the accompanying drawings, in which:

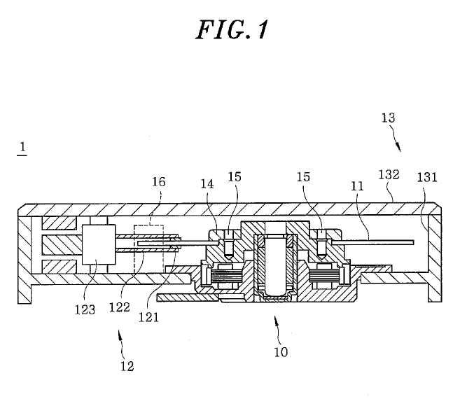

FIG. 1 is a sectional view showing a storage disk drive apparatus in accordance with a first embodiment of the present invention, which view is taken along a plane containing the center axis of the apparatus;

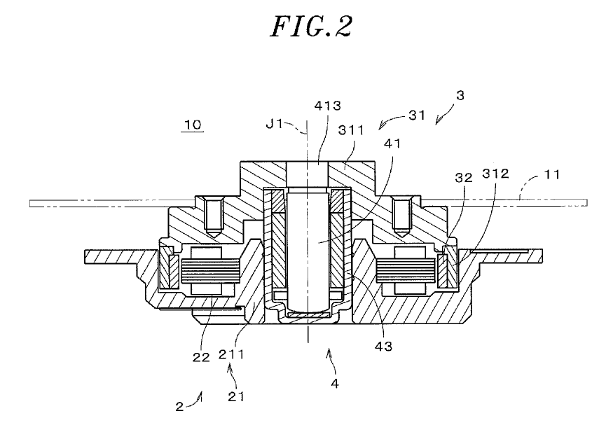

FIG. 2 is a sectional view of a motor taken along a plane containing the center axis;

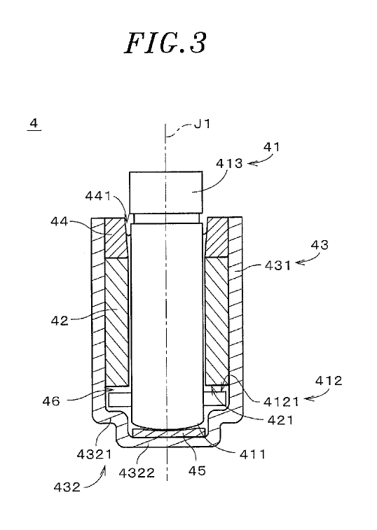

FIG. 3 is a sectional view of a bearing mechanism taken along a plane containing the center axis;

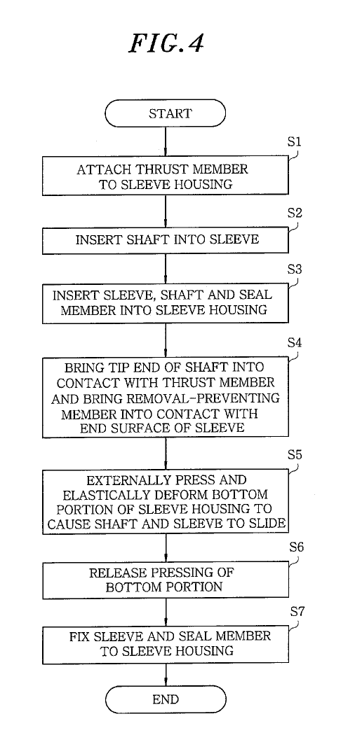

FIG. 4 is a view illustrating a process through which the bearing mechanism is manufactured;

FIGS. 5 through 10 are views showing the bearing mechanism under a manufacturing process;

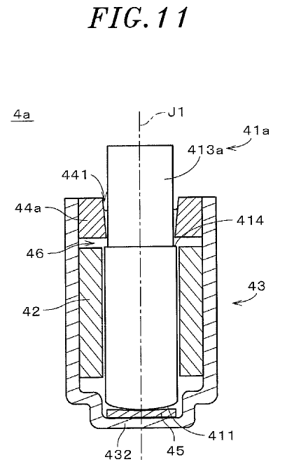

FIG. 11 is a sectional view of the bearing mechanism in accordance with a modified example of the first embodiment, taken along a plane containing the center axis;

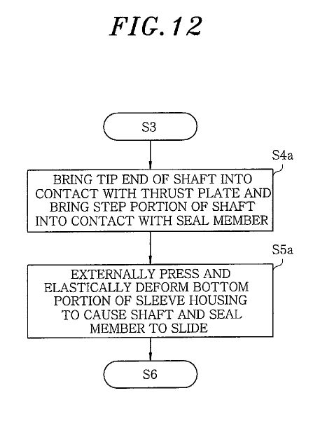

FIG. 12 is a view illustrating a part of the process through which the bearing mechanism is manufactured;

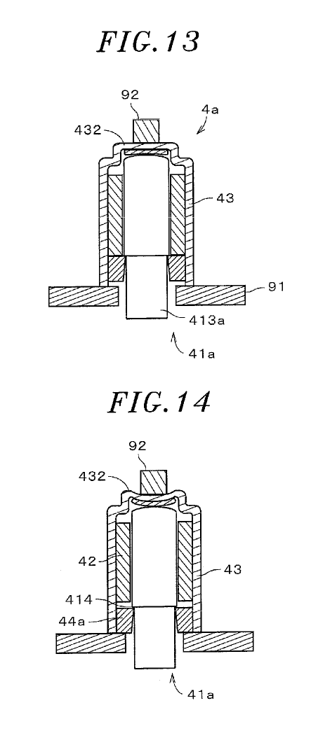

FIGS. 13 through 15 are views showing the bearing mechanism under a manufacturing process;

FIG. 16 is a sectional view of a bearing mechanism in accordance with another modified example of the first embodiment, taken along a plane containing the center axis;

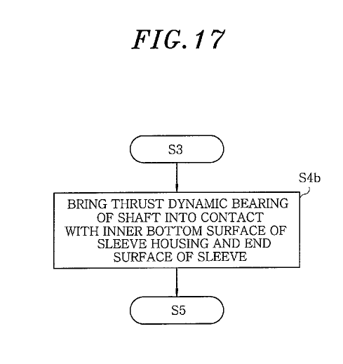

FIG. 17 is a view illustrating a part of the process through which the bearing mechanism is manufactured;

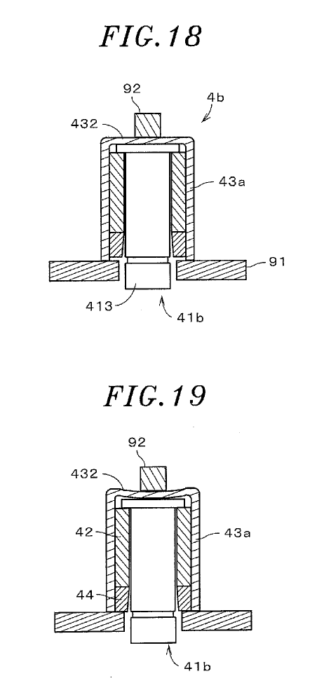

FIGS. 18 through 20 are views showing the bearing mechanism under a manufacturing process;

FIG. 21 is a view showing a bearing mechanism in accordance with a second embodiment of the present invention.

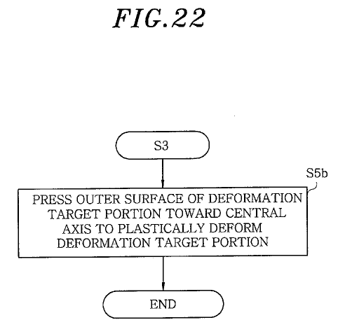

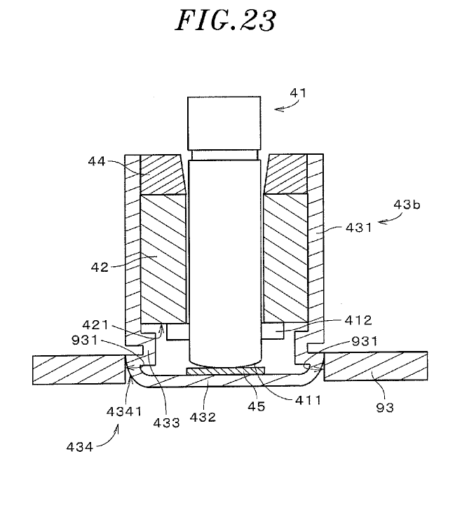

FIG. 22 is a view illustrating a part of the process through which the bearing mechanism is manufactured;

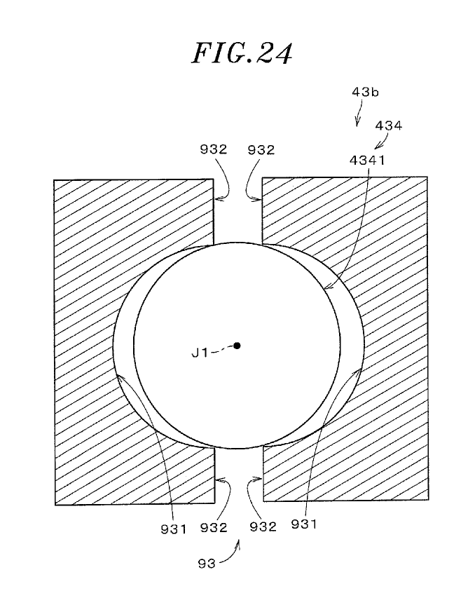

FIGS. 23 and 24 are views showing the bearing mechanism under a manufacturing process;

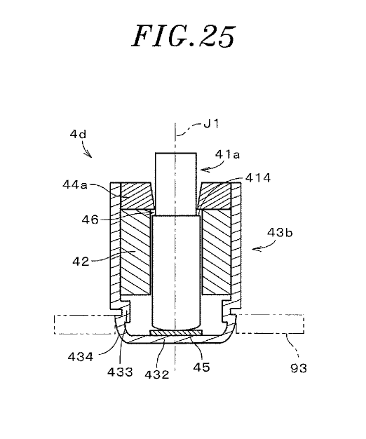

FIG. 25 is a view showing a bearing mechanism in accordance with a modified example of the second embodiment;

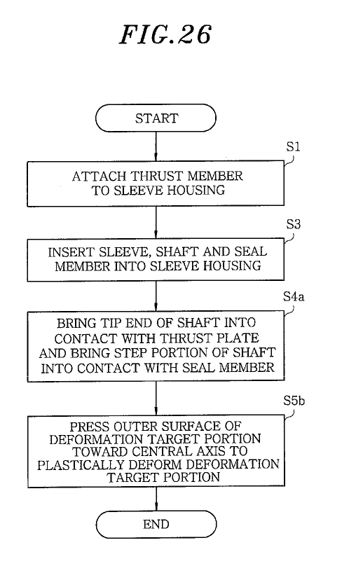

FIG. 26 is a view illustrating a process through which the bearing mechanism is manufactured;

FIG. 27 is a view showing the bearing mechanism under a manufacturing process;

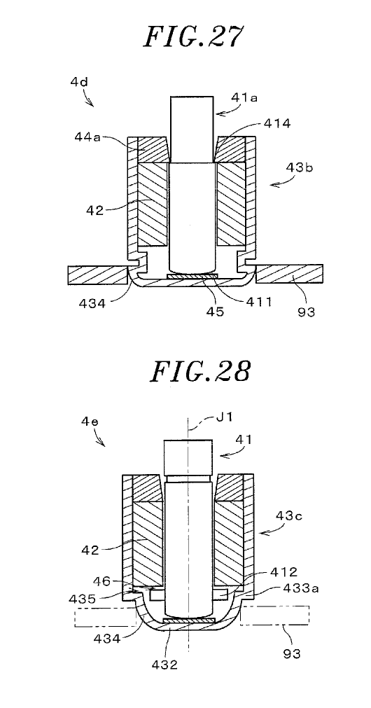

FIG. 28 is a view showing a bearing mechanism in accordance with another modified example of the second embodiment;

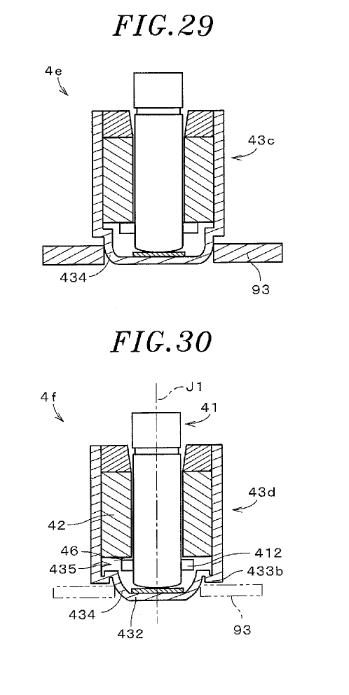

FIG. 29 is a view showing the bearing mechanism under a manufacturing process;

FIG. 30 is a view showing a bearing mechanism in accordance with another modified example of the second embodiment;

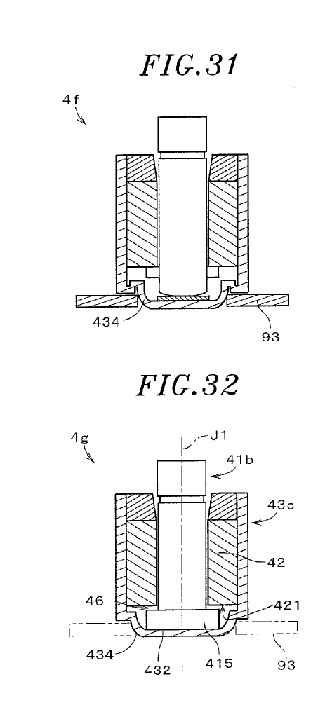

FIG. 31 is a view showing the bearing mechanism under a manufacturing process;

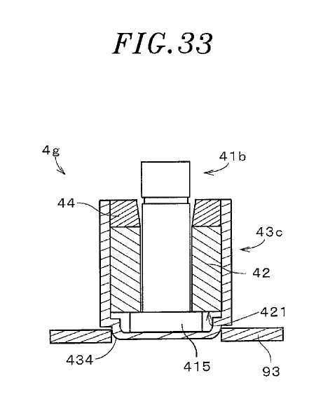

FIG. 32 is a view showing a bearing mechanism in accordance with another modified example of the second embodiment; and

FIG. 33 is a view showing the bearing mechanism under a manufacturing process.

### DETAILED DESCRIPTION OF THE PREFERRED EMBODIMENTS

FIG. 1 is a sectional view showing a storage disk drive apparatus 1 provided with an electric spindle motor (hereinafter referred to as a “motor”) in accordance with a first embodiment of the present invention. In the description made herein, the terms “upper”, “lower”, “left” and “right” used for explaining the positional relationships and orientations of individual members are intended to designate those in the drawings and not to designate the positional relationships and orientations when they are built in an actual device.

The storage disk drive apparatus 1 is what is called as a hard disk drive, and includes a circular plate-like storage disk 11 for storing data; an access unit 12 for reading and writing data from/to the storage disk 11; an electric motor 10 for holding and rotating the storage disk 11; and a housing 13 for receiving the storage disk 11, the motor 10 and the access unit 12 within an internal space thereof.

The housing 13 includes a first housing member 131 of cover-free box-like shape having an opening formed in its upper portion, the first housing member 131 having an inner bottom surface on which the motor 10 and the access unit 12 are mounted; and a second housing member 132 of plate-like shape for covering the opening of the first housing member 131. In the storage disk drive apparatus 1, the second housing member 132 is affixed to the first housing member 131 to form the housing 13. The housing 13 has a clean internal space in which dust is extremely rare.

The storage disk 11 is mounted on the upper side of the motor 10, and is fixed to the motor 10 by means of a clamp 14 and screws 15. The access unit 12 includes a head portion 121 for accessing the storage disk 11 to magnetically perform reading and writing of data; an arm 122 for supporting the head portion 121; and a head moving mechanism 123 for moving the arm 122 so that the head portion 121 is moved with respect to the storage disk 11 and the motor 10. The head portion 121 is moved by the head moving mechanism 123 to above the storage disk 11 during its rotation. When the storage disk 11 is stopped, the head portion 121 is moved away from the storage disk 11, and is held on a ramp portion 16 as indicated by a broken line in FIG. 1. With this construction, the head portion 121 gains access to a desired position on the storage disk 11 in a state that it is close to the storage disk 11 under rotation, thereby performing the task of reading and writing data.

FIG. 2 is a sectional view of the motor 10 taken along a plane containing the center axis thereof, in which view the storage disk 11 is indicated by a double-dotted chain line. The motor 10 is of an outer rotor type, and includes a stator unit 2 as a fixed assembly, a rotor unit 3 as a rotating assembly and a bearing mechanism 4. The rotor unit 3 is mounted to the upper end portion 413 of a shaft 41 of the bearing mechanism 4, and is supported by the bearing mechanism 4 such that it can rotate relative to the stator unit 2 about the center axis J1 of the motor 10. In the following description, the direction toward the rotor unit 3 along the central axis J1 will be denoted by the term “upper”, and the direction toward the stator unit 4 along the central axis J1 will be signified by the term “lower”, for convenience. However, it is not necessary for the center axis J1 to coincide with the direction of gravity.

The rotor unit 3 includes a rotor hub 31, made of stainless steel or the like, serving as a main body of the rotor unit 3; and a rotor magnet 32. The rotor hub 31 includes a substantially disk-like circular plate portion 311, attached to an upper end portion 413 of the shaft 41, extending at a right angle with respect to the center axis J1; and a substantially cylindrical yoke 312 protruding downwardly from the outer circumference of the circular plate portion 311. The rotor magnet 32 is attached to the inner surface of the yoke 312.

The stator unit 2 includes a base bracket 21 having a substantially cylindrical holder 211 formed at the center thereof; and a stator 22 attached to and around the holder 211. A substantially cylindrical bottom-closed sleeve housing 43 in the bearing mechanism 4 mentioned below is received in and fixed to the holder 211. The stator 22 is radially opposite the rotor magnet 32. The stator 22 generates a rotational force (torque) acting about the shaft 41 (namely, about the center axis J1) between itself and the rotor magnet 32.

FIG. 3 is a view showing the bearing mechanism 4. The bearing mechanism 4 includes a shaft 41; a cylindrical sleeve 42 in which the shaft 41 is received; a substantially cylindrical bottom-closed sleeve housing 43 in which the sleeve 42 is received; an annular seal member 44 arranged above the sleeve 42; and a thrust member 45 arranged on the inner bottom surface of the sleeve housing 43. The sleeve 42 is a porous member made of sintered metal. The sleeve housing 43 and the seal member 44 serve to retain the lubricant with which the sleeve 42 is impregnated.

The shaft 41, formed into a cylinder shape about the center axis J1, has an upper end portion 413 protruding upwardly from the sleeve housing 43; and a lower end portion 411 of a partial sphere shape bulged downwardly (toward the thrust member 45). An annular removal-preventing member 412 coaxial with the center axis J1 is attached to the outer circumferential surface of the shaft 41 near the lower end portion 411. In other words, the shaft 41 includes a plate portion that serves as the removal-preventing member 412. The sleeve 42 has an outer surface fixed within the sleeve housing 43; and an inner surface radially supporting the shaft 41 via the lubricant. The sleeve 42 has a lower surface 421 being opposite the upper surface 4121 of the removal-preventing member 412 attached to the shaft 41. Between the upper surface 4121 of the removal-preventing member 412 and the lower surface 421 of the sleeve 42 is formed an axial gap 46 of 10 to 40 μm (although its size is exaggerated in FIG. 3) that corresponds to the width range within which the shaft 41 is axially movable with respect to the sleeve housing 43. As the shaft 41 is moved upwardly, the upper surface 4121 of the removal-preventing member 412 and the lower surface 421 of the sleeve 42 make contact with each other, thereby preventing the shaft 41 from being removed from the sleeve 42.

The sleeve housing 43 has a cylindrical side portion 431, and a substantially dish-like bottom portion 432. Further, the sleeve housing 43 is formed into a single continuously extending member by pressing a spring steel plate. The bottom portion 432 has a substantially annular step portion 4321 extending inwardly toward the center axis J1 from the lower end of the side portion 431; and a substantially cylindrical bottom-closed thrust member holding portion 4322 whose upper end joins to an inner periphery of the step portion 4321. The thrust member 45 is of a substantially disk-like shape, and is disposed within the thrust member holding portion 4322. Further, the thrust member 45 is made of a low-friction synthetic resin, and, on the upper surface thereof is formed a recess portion of a partial sphere shape that is approximately same as the lower end portion 411 of the shaft 41. The lower end portion 411 of the shaft 41 and the thrust member 45 constitute a pivot bearing that allows the shaft 41 to rotate while in contact with the upper surface of the thrust member 45 somewhere along the center axis J1. An annular tapering gap 441 whose width is gradually increased with increasing distance from the sleeve 42 is formed between the shaft 41 and the seal member 44. The lubricant retained between the shaft 41 and the sleeve 42 has a boundary surface formed within the tapering gap 441. This prevents the lubricant from leaking out of the bearing mechanism 4.

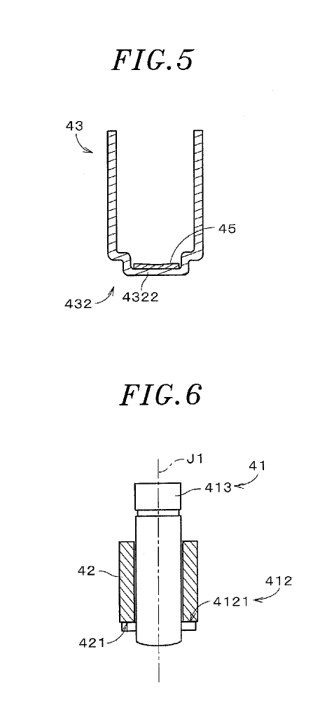

FIG. 4 is a view showing a process through which the bearing mechanism 4 is manufactured. FIGS. 5 through 10 are views illustrating the bearing mechanism 4 under a manufacturing process. As shown in FIG. 5, the thrust member 45 is first arranged on the inner bottom surface of the sleeve housing 43 (namely, the inner bottom surface of the thrust member holding portion 4322 of the bottom portion 432) (step S1). The thrust member 45 may be fixed to the inner bottom surface of the sleeve housing 43 by means of an adhesive agent or the like (this holds true also in case of the below-mentioned other embodiments). As shown in FIG. 6, the upper end portion 413 of the shaft 41 is inserted into the sleeve 42 from the lower surface 421 of the sleeve 42 so that the upper surface 4121 of the removal-preventing member 412 fixed to the shaft 41 makes contact with the lower surface 421 of the sleeve 42 (step S2). A thermally curable adhesive agent is applied on the outer surfaces of the sleeve 42 and the seal member 44. Herein, the seal member 44 and the sleeve 42 may constitute an annular member.

Next, as shown in FIG. 7, an assembly of the shaft 41 and the sleeve 42 (see FIG. 6) is inserted from the lower end portion 411 of the shaft 41 into the sleeve housing 43 in which the thrust member 45 is arranged on the inner bottom surface of the bottom portion 432. Then, the sleeve 42 is fitted into the sleeve housing 43, and the seal member 44 is also fitted into the sleeve housing 43 to make contact with the upper surface of the sleeve 42 (step S3). At this time, the lower end portion 411 of the shaft 41 inserted into the sleeve 42 comes into contact with the upper surface of the thrust member 45, and the lower surface 421 of the sleeve 42 makes contact with the upper surface 4121 of the removal-preventing member 412 (in other words, the lower surface 421 of the sleeve 42 is brought into indirect contact with the shaft 41 in the direction leading from the opening of the sleeve housing 43 to the bottom portion 432). Thus, the position of the sleeve 42 is set relative to the center axis J1 (step S4). The sleeve 42 is lightly press-fitted and tentatively fixed to the inner surface of the sleeve housing 43 in a slidable manner. Like the sleeve 42, the seal member 44 is also tentatively fixed within the sleeve housing 43.

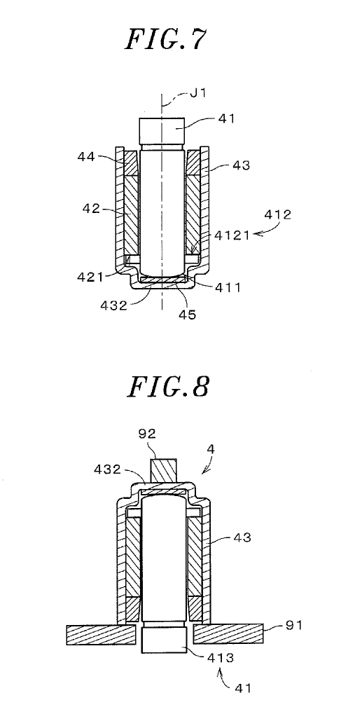

Thereafter, as shown in FIG. 8, the bearing mechanism 4 is placed on a jig 91 having a central aperture which the shaft 41 passes through in an upward direction relative to the direction of gravity. Thus, the end portion of the sleeve housing 43 that exists on the same side as the opening of the sleeve housing 43 is brought into contact with the jig 91. A pressing device 92 arranged above the bearing mechanism 4 makes contact with the center of the lower surface (shown in the upper side in FIG. 8) of the bottom portion 432 of the sleeve housing 43. In this manner, it becomes possible to measure the position of the upper end portion 413 (shown in the lower side in FIG. 8) of the shaft 41 using an external measuring instrument.

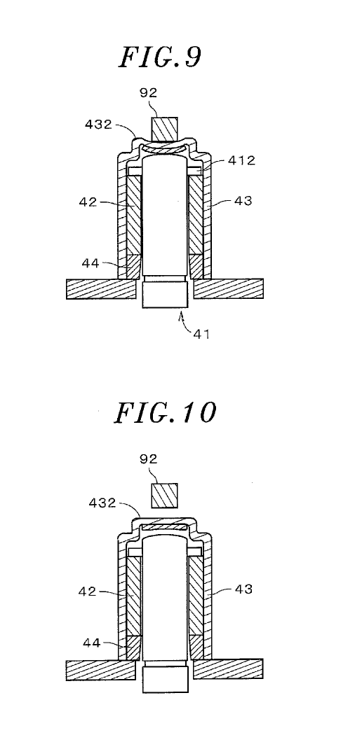

As shown in FIG. 9, the pressing device 92 downwardly presses the center of the bottom portion 432 of the sleeve housing 43, in response to which the bottom portion 432 is elastically deformed and downwardly bulged into a convex shape (as exaggeratedly shown in FIG. 9). At this time, the shaft 41 remaining in contact with the bottom portion 432 is slid downwardly (toward the opening of the sleeve housing 43). As set forth earlier, the sleeve 42 is slidable with respect to the sleeve housing 43, and is kept in contact with the removal-preventing member 412 fixed to the shaft 41. Therefore, the sleeve 42 and the seal member 44 are also moved toward the opening of the sleeve housing 43 together with the shaft 41 (step S5). The displacement amount of the shaft 41 is measured while the sleeve 42 and the seal member 44 are in motion. When the displacement amount of the shaft 41 reaches a specified value, the pressing device 92 is moved upwardly as shown in FIG. 10 to thereby release the pressing of the bottom portion 432 (step S6). In response, the bottom portion 432 is restored to its original shape, but the sleeve 42 and the seal member 44 stay in the displaced positions. The sleeve housing 43 is externally heated to cure the thermally curable adhesive agent existing between the sleeve 42 and the sleeve housing 43 and between the seal member 44 and the sleeve housing 43. Thus, the sleeve 42 and the seal member 44 are firmly fixed within the sleeve housing 43 so that they are no longer movable (step S7).

Next, the bearing mechanism 4 is separated from the jig 91, and is so laid that the bottom portion 432 of the sleeve housing 43 faces downward, and the lower end portion 411 of the shaft 41 comes into contact with the thrust member 45 in the same manner as in FIG. 3. Thus, an axial gap 46, equivalent to the displacement amount of the sleeve 42 and the seal member 44 during the elastic deformation of the bottom portion 432, is formed between the upper surface 4121 of the removal-preventing member 412 and the lower surface 421 of the sleeve 42.

As described above, in the manufacture of the bearing mechanism 4 in the first embodiment, the axial gap 46 that allows the shaft 41 to move along the center axis J1 can be easily and accurately formed by elastically deforming the bottom portion 432 of the sleeve housing 43. It is also possible to easily fix the sleeve 42 in a slidable manner by lightly press-fitting the sleeve 42 into the sleeve housing 43. Furthermore, it is also possible to prevent occurrence of stress concentration during the elastic deformation by forming the bottom portion 432 of the sleeve housing 43 into a circular shape. Use of the sleeve housing 43 made of spring steel makes it possible to easily cause the elastic deformation. Moreover, it is also possible to more accurately form the axial gap 46 by measuring the displacement amount of the shaft 41 when pressing the bottom portion 432 of the sleeve housing 43.

FIG. 11 is a view showing a bearing mechanism 4a in accordance with a modified example of the first embodiment. The bearing mechanism 4a is used in a motor for a storage disk drive apparatus, which is the same as the motor 10 shown in FIG. 2. The bearing mechanism 4a includes a shaft 41a and a seal member 44a, both of which differ in shape from those of the bearing mechanism 4 shown in FIG. 3. However, the sleeve 42, the sleeve housing 43 and the thrust member 45 are the same as those in FIG. 3.

The shaft 41a, formed into a cylinder shape surrounding the center axis J1, has an upper end portion 413a protruding upward beyond the sleeve housing 43; and a lower end portion 411 of a partial sphere shape bulged downward (toward the thrust member 45). A shaft step portion 414 whose diameter is decreased on the side of the upper end portion 413a is formed in the boundary between a portion of the shaft 41a received within the sleeve 42 and the upper end portion 413a of the shaft 41a. The upper end portion 413a is of a cylinder shape and has an outer diameter smaller than that of the remaining portion of the shaft 41a extending below the shaft step portion 414. In the present modified example, the seal member 44a and the sleeve 42 may constitute an annular member.

The seal member 44a is arranged closer to the opening of the sleeve housing 43 than to the bottom portion 432 of the sleeve housing 43, and has an inner surface of tapering shape whose diameter is gradually increased with increasing height. Also, the seal member 44a has a lower surface whose inner diameter is smaller than the outer diameter of the portion of the shaft 41a extending below the shaft step portion 414.

Between the lower surface of the seal member 44 and the upper surface of the sleeve 42 is formed an axial gap 46 that allows the shaft 41a to move along the center axis J1 (the axial gap 46 is exaggeratedly shown in FIG. 11). If the shaft 41a is moved upwardly, the shaft step portion 414 makes contact with the lower surface of the seal member 44a, whereby the seal member 44a prevents the shaft 41a from being pulled out of the bearing mechanism 4a. An annular tapering gap 441 whose width is gradually increased with increasing distance from the sleeve 42 is formed between the shaft 41a and the seal member 44a. The lubricant retained between the shaft 41a and the sleeve 42 has a boundary surface formed within the tapering gap 441. This prevents the lubricant from leaking out of the bearing mechanism 4a.

The sleeve 42 has an outer surface fixed within the sleeve housing 43, and an inner surface that radially supports the shaft 41a via the lubricant. The thrust member 45 of substantially plate-like shape is arranged on the inner bottom surface of the bottom portion 432 of the sleeve housing 43, thereby providing a pivot bearing that allows the lower end portion 411 of the shaft 41a to rotate while in contact with the upper surface of the thrust member 45 somewhere along the center axis J1.

FIG. 12 is a view illustrating a part of the process through which the bearing mechanism 4a is manufactured, and FIGS. 13 through 15 are views showing the bearing mechanism 4a under the manufacturing process. In the manufacture of the bearing mechanism 4a, step S2 for manufacturing the bearing mechanism 4 illustrated in FIG. 4 is omitted, and steps S4a and S5a illustrated in FIG. 12 are performed in place of steps S4 and S5. First, the thrust member 45 is arranged on the inner bottom surface of the sleeve housing 43 as shown in FIG. 5 (step S1). A thermally curable adhesive agent is applied on the outer surfaces of the sleeve 42 and the seal member 44a. Then, the sleeve 42 is fitted into the sleeve housing 43, the shaft 41a is inserted into the sleeve 42, and the seal member 44a is fitted into the sleeve housing 43 (step S3).

At this time, the lower end portion 411 of the shaft 41a makes contact with the thrust member 45, and the shaft step portion 414 of the shaft 41a comes into contact with the surface of the seal member 44a facing the sleeve 42, whereby the position of the seal member 44a is set within the sleeve housing 43 (step S4a). Further, the seal member 44a and the sleeve 42 are lightly press-fitted to and tentatively fixed within the sleeve housing 43 so that they can make sliding movement with respect to the inner surface of the sleeve housing 43.

Thereafter, as shown in FIG. 13, the bearing mechanism 4a is placed on a jig 91 having a central aperture which the shaft 41a passes through in an upward direction relative to the direction of gravity. Thus, the side end portion of the sleeve housing 43 that exists on the same side as the opening of the sleeve housing 43 is brought into contact with the jig 91. A pressing device 92 arranged above the bearing mechanism 4a makes contact with the center of the lower surface (shown on the upper side in FIG. 13) of the bottom portion 432 of the sleeve housing 43. In this manner, it becomes possible to measure the position of the upper end portion 413a (shown on the lower side in FIG. 13) of the shaft 41a using an external measuring instrument.

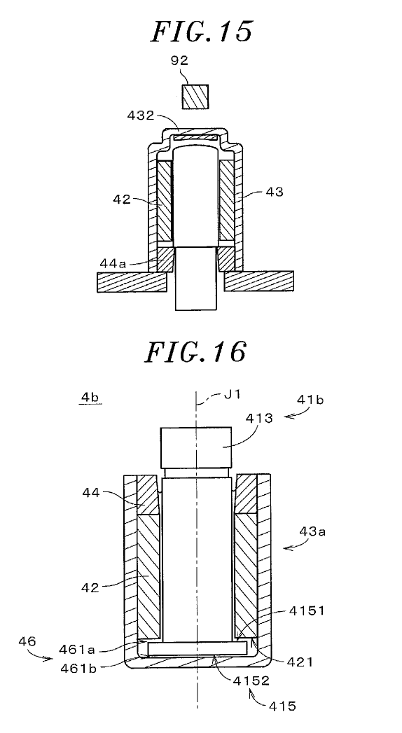

If the pressing device 92 downwardly presses the center of the bottom portion 432 of the sleeve housing 43 as shown in FIG. 14, the bottom portion 432 is elastically deformed and downwardly bulged into a convex shape. At this time, the shaft 41a remaining in contact with the bottom portion 432 is slid downwardly (toward the opening of the sleeve housing 43). As set forth earlier, the seal member 44a is slidable with respect to the sleeve housing 43, and the shaft step portion 414 of the shaft 41a is kept in contact with the surface of the seal member 44a facing the sleeve 42. Therefore, the seal member 44a is also moved toward the opening of the sleeve housing 43 together with the shaft 41a (step S5a). The displacement amount of the shaft 41a is measured while the seal member 44a is in motion. When the displacement amount of the shaft 41a reaches a specified value, the pressing device 92 is moved upwardly as shown in FIG. 15 to thereby release the pressing of the bottom portion 432 (step S6). In response, the bottom portion 432 is restored to its original shape, but the seal member 44a stays in the displaced position. The sleeve housing 43 is externally heated to cure the thermally curable adhesive agent existing between the sleeve 42 and the sleeve housing 43 and between the seal member 44a and the sleeve housing 43. Thus, the sleeve 42 and the seal member 44a are firmly fixed within the sleeve housing 43 so that they are no longer movable (step S7).

Next, the bearing mechanism 4a is separated from the jig 91, and is so placed that the bottom portion 432 of the sleeve housing 43 faces downward, and the lower end portion 411 of the shaft 41a comes into contact with the thrust member 45 as shown in FIG. 11. In this manner, an axial gap 46 equivalent to the displacement amount of the seal member 44a during the elastic deformation of the bottom portion 432 is formed between the shaft step portion 414 of the shaft 41a and the lower surface of the seal member 44a.

As described above, in the manufacture of the bearing mechanism 4a of the modified example, the axial gap 46 that allows the shaft 41a to move along the center axis J1 can be easily and accurately formed by elastically deforming the bottom portion 432 of the sleeve housing 43. It is also possible to easily fix the seal member 44a in a slidable manner by lightly press-fitting the seal member 44a into the sleeve housing 43. Furthermore, it is possible to prevent occurrence of stress concentration during the elastic deformation by forming the bottom portion 432 of the sleeve housing 43 into a circular shape. In addition, it is possible to more accurately form the axial gap 46 by measuring the displacement amount of the shaft 41a when pressing the bottom portion 432 of the sleeve housing 43.

FIG. 16 is a view showing a bearing mechanism 4b in accordance with another modified example of the first embodiment. The bearing mechanism 4b is used in a motor for a storage disk drive apparatus, which is the same as the motor 10 shown in FIG. 2. The bearing mechanism 4b includes a substantially cylindrical shaft 41b formed about the center axis J1; a cylindrical sleeve 42 in which the shaft 41b is received; a substantially cylindrical bottom-closed sleeve housing 43a in which the sleeve 42 is received; and an annular seal member 44. The lubricant is filled in the bearing mechanism 4b, and the sleeve housing 43a and the seal member 44 serve to retain the lubricant.

The shaft 41b has an upper end portion 413 protruding upward beyond the sleeve housing 43a; and a lower end portion provided with a substantially disk-like thrust plate 415 extending in the radially outward direction from the outer circumferential surface of the shaft 41b. The thrust plate 415 may form a plate portion. Dynamic pressure grooves (of, e.g., spiral shape) are formed on the upper surface 4151 and the lower surface 4152 of the thrust plate 415. Thus, as the shaft 41b is rotated, a dynamic pressure is generated in the lubricant between the upper surface 4151 of the thrust plate 415 and the lower surface 421 of the sleeve 42 and/or between the lower surface 4152 of the thrust plate 415 and the inner bottom surface of the sleeve housing 43a. Thus, the upper and the lower surface 4151 of the thrust plate 415 form a thrust dynamic bearing that axially supports the shaft 41b. At this time, thrust gaps 461a and 461b are formed between the thrust plate 415 and the sleeve 42 and between the thrust plate 415 and the sleeve housing 43a, respectively. In the following description, the total sum of the axial width of the thrust gaps 461a and 461b, i.e., the distance over which the shaft 41b is allowed to axially move during stoppage thereof, will be referred to as an axial gap 46.

FIG. 17 is a view illustrating a part of the process through which the bearing mechanism 4b is manufactured. FIGS. 18 through 20 are views showing the bearing mechanism 4b under the manufacturing process. In the manufacturing process of the bearing mechanism 4b, step S1 illustrated in FIG. 4 is omitted, and step S4 is replaced with step S4b shown in FIG. 17. First, the shaft 41b is inserted into the sleeve 42 until the lower surface 421 of the sleeve 42 shown in FIG. 16 comes into contact with the upper surface 4151 of the thrust plate 415 (step S2). A thermally curable adhesive agent is applied on the outer surfaces of the sleeve 42 and the seal member 44. Then, an assembly of the shaft 41b, the sleeve 42 and the seal member 44 are inserted into the sleeve housing 43a (step S3).

Thus, the lower end of the shaft 41b (namely, the lower surface 4152 of the thrust plate 415) makes contact with the inner bottom surface of the sleeve housing 43a, and the upper surface 4151 of the thrust plate 415 comes into contact with the lower surface 421 of the sleeve 42. Furthermore, the seal member 44 makes contact with the upper surface of the sleeve 42, whereby the positions of the sleeve 42 and the seal member 44 are set (step S4b). At this time, the sleeve 42 and the seal member 44 are lightly press-fitted to and fixed within the sleeve housing 43a so that they can make sliding movement with respect to the inner surface of the sleeve housing 43a.

Thereafter, as shown in FIG. 18, the bearing mechanism 4b is so placed on a jig 91 that the bottom portion 432 of the sleeve housing 43a faces upward relative to the direction of gravity. A pressing device 92 arranged above the bearing mechanism 4b makes contact with the center of the lower surface of the bottom portion 432 of the sleeve housing 43a. Thus, it becomes possible to measure the position of the upper end portion 413 (shown on the lower side in FIG. 18) of the shaft 41b using an external measuring instrument.

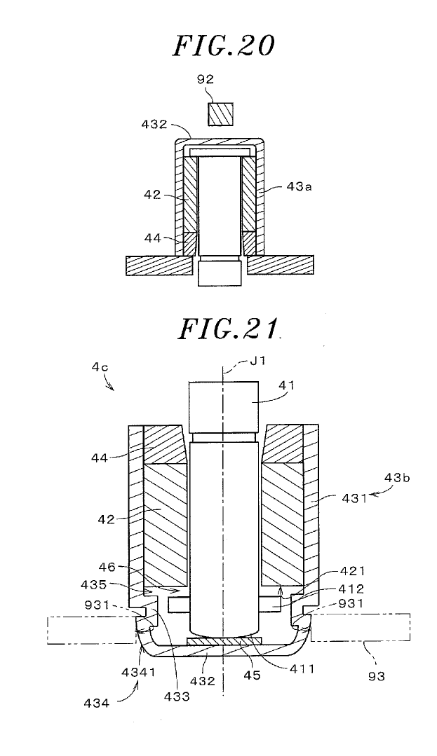

If the pressing device 92 downwardly presses the center of the bottom portion 432 of the sleeve housing 43a as shown in FIG. 19, the bottom portion 432 is elastically deformed and downwardly bulged into a convex shape. In response, the shaft 41b is slid downwardly (toward the opening of the sleeve housing 43a), and the sleeve 42 and the seal member 44 are also moved toward the opening of the sleeve housing 43a (step S5). When the displacement amount of the shaft 41b reaches a specified value, the pressing device 92 is moved upward as shown in FIG. 20 to thereby release the pressing of the bottom portion 432 (step S6). In response, the bottom portion 432 is restored to its original shape, but the sleeve 42 and the seal member 44 stay in the displaced positions. The thermally curable adhesive agent existing between the sleeve 42 and the sleeve housing 43a and between the seal member 44 and the sleeve housing 43a are cured by being heated. Thus, the sleeve 42 and the seal member 44 are firmly fixed within the sleeve housing 43a so that they are no longer movable (step S7).

Next, the bearing mechanism 4b is separated from the jig 91, and is so placed that the bottom portion 432 of the sleeve housing 43a faces downward. Thus, an axial gap 46 equivalent to the displacement amount of the sleeve 42 the seal member 44 during the elastic deformation of the bottom portion 432 is formed on the upper side of the thrust plate 415 (see FIG. 16). Then, the lubricant is filled in the sleeve housing 43a.

As described above, in the manufacture of the bearing mechanism 4b of the present modified example, the axial gap 46 extending along the center axis J1 of the shaft 41b can be easily and accurately formed by elastically deforming the bottom portion 432 of the sleeve housing 43. As with the bearing mechanism 4 in the first embodiment, it is also possible to easily fix the sleeve 42 in a slidable manner by lightly press-fitting the same. Furthermore, it is possible to prevent occurrence of stress concentration during the elastic deformation by forming the bottom portion 432 of the sleeve housing 43a into a circular shape. In addition, it is possible to more accurately form the axial gap 46 by measuring the displacement amount of the shaft 41b.

FIG. 21 is a view showing a bearing mechanism 4c in accordance with a second embodiment of the present invention. The bearing mechanism 4c includes a substantially cylindrical shaft 41; an annular sleeve 42 in which the shaft 41 is received; a substantially cylindrical bottom-closed sleeve housing 43b in which the sleeve 42 is received; an annular seal member 44 arranged near the opening of the sleeve housing 43b; and a substantially plate-like thrust member 45 arranged on the inner bottom surface of the sleeve housing 43b. A lubricant is filled in the bearing mechanism 4c. The sleeve housing 43b and the seal member 44 serve to retain the lubricant.

As compared to the bearing mechanism 4 shown in FIG. 3, the bearing mechanism 4c differs in the shape of the sleeve housing 43b and in the method of forming the axial gap 46. The same pivot bearing as employed in the bearing mechanism 4 is provided by the shaft 41, the sleeve 42, the seal member 44 and the thrust member 45.

The sleeve housing 43b includes a cylindrical side portion 431, a bottom portion 432 and a step portion 433 formed below the side portion 431. Further, the sleeve housing 43b is formed into a single continuously-extending member by pressing a plate. The step portion 433, formed in an annular shape about the center axis J1, protrudes toward the center axis J1 from the inner surface of the side portion 431. In other words, the step portion 433 includes a first portion near the bottom portion and a second portion axially closer to the bottom portion 432 than the first position, and the diameter of the step portion 433 once decreases at the first portion, and then increases at the second portion to a length slightly smaller than the diameter of the side portion 431. A gap 435 is formed between the lower surface 421 of the sleeve 42 and the step portion 433.

FIG. 22 is a view illustrating a part of the process through which the bearing mechanism 4c is manufactured, and FIGS. 23 and 24 are views showing the bearing mechanism 4c under the manufacturing process. In the manufacturing process of the bearing mechanism 4c, step S4 is slightly different from that in the manufacturing process of the bearing mechanism 4 illustrated in FIG. 4. Further, Step S5b illustrated in FIG. 22 is performed in place of step S5, and steps S6 and S7 are omitted. First, the thrust member 45 is arranged on the bottom portion 432 of the sleeve housing 43b (step S1). The shaft 41 is inserted into the sleeve 42 that has been prepared separately (step S2). Then, a thermally curable adhesive agent is applied on the outer surfaces of the sleeve 42 and the seal member 44. As shown in FIG. 23, an assembly of the sleeve 42, the shaft 41 and the seal member 44 are fitted into the sleeve housing 43b (step S3).

At this time, the lower end portion 411 of the shaft 41 comes into contact with the thrust member 45, and the removal-preventing member 412 makes contact with the sleeve 42 (namely, the sleeve 42 is brought into indirect contact with the shaft 41 in the direction leading from the opening of the sleeve housing 43b to the bottom portion 432), whereby the positions of the sleeve 42 and the seal member 44 are set. Thereafter, the sleeve housing 43b is heated from outside to cure the adhesive agent existing between the sleeve 42 and the sleeve housing 43b and between the seal member 44 and the sleeve housing 43b. By doing so, the sleeve 42 and the seal member 44 are affixed within the sleeve housing 43b (step S4). The shaft 41 includes a plate portion, which is in this case the removal-preventing member 412.

At the time of step S4, the outer diameter of the portion of the sleeve housing 43b extending from the step portion 433 to the bottom portion 432 is equal to the outer diameter of the side portion 431. This portion of the sleeve housing 43b is subjected to plastic deformation in step S5b as described later, and therefore will be referred to as a “deformation target portion 434”. The deformation target portion 434 may be approximately regarded as the portion lying between the inner bottom surface of the sleeve housing 43b and the lower surface 421 of the sleeve 42. The lower extension of the deformation target portion 434 has an outer diameter gradually decreasing with decreasing height.

FIG. 24 is a bottom plan view of the sleeve housing 43b and a pressing device 93. The pressing device 93 is a working tool of thick plate shape, and is divided into two members having semicircular portions 931, i.e., semicircular concave portions, being opposite each other with the center axis J1 lying therebetween; and contact surfaces 932 capable of making contact with each other. The diameter of the circle formed by the semicircular portions 931 when the contact surfaces 932 are in contact with each other is slightly smaller than the diameter of the outer surface 4341 of the deformation target portion 434. After the manufacturing process up to step S4 is completed, the upper portion of the side portion 431 of the sleeve housing 43b is held by a jig (not shown in the drawings), and the outer surface 4341 of the deformation target portion 434 is arranged between the semicircular portions 931 of the pressing device 93 as shown in FIGS. 23 and 24.

As indicated by double-dotted chain lines in FIG. 21, the semicircular portions 931 of the pressing device 93 are moved toward the center axis J1 to grip the outer surface 4341 of the deformation target portion 434. The outer surface 4341 of the deformation target portion 434 is pressed toward the center axis J1 until the contact surfaces 932 (see FIG. 24) come into contact with each other. As a result, the deformation target portion 434 is subject to a plastic deformation, and the diameter of the outer surface 4341 is reduced to become equal to the diameter of the circle formed by the semicircular portions 931. Since the deformation target portion 434 has an outer diameter gradually decreasing with decreasing height, the central portion of the bottom portion 432 is pushed downwardly away from the shaft 41 (step S5b). At this time, the stepped shape of the step portion 433 prevents the plastic deformation from being spread to the portion of the sleeve housing 43b lying above the step portion 433, thereby keeping the diameter of the sleeve 42 from being affected.

As the bottom portion 432 is pushed downwardly, the thrust member 45 and the shaft 41 are also moved downwards, thereby creating an axial gap 46 of about 10 to 40 μm between the removal-preventing member 412 and the lower surface 421 of the sleeve 42. When the pressing device 93 is removed from the sleeve housing 43b after the pressing operation in step S5b, the diameter of the outer surface of the deformation target portion 434 is slightly increased again. The pressing device 93 is designed by taking this restoring amount into account.

As described above, the sleeve housing 43b in the bearing mechanism 4c is directly deformed. Therefore, the axial gap 46 that allows the shaft 41 to move along the center axis J1 can be formed easily and cost-effectively without using a high-precision component or a sophisticated mechanism for position setting. Further, presence of the step portion 433 prevents the plastic deformation from affecting the inner diameter of the sleeve 42. In addition, forming the gap 435 between the lower surface 421 and the step portion 433 of the sleeve 42 also prevents the plastic deformation from affecting the inner diameter of the sleeve 42. Further, by forming the bottom portion 432 into a circular shape, stress concentration can be avoided to allow the plastic deformation uniform in the circumferential direction, which in turn makes it possible to accurately form the axial gap 46.

FIG. 25 is a view showing a bearing mechanism 4d in accordance with a modified example of the second embodiment. The bearing mechanism 4d includes a sleeve housing 43b having a deformation target portion 434 and a step portion 433, which is the same as in the bearing mechanism 4c shown in FIG. 21. The shaft 41a, the seal member 44a, the sleeve 42 and the thrust member 45 are the same as those of the bearing mechanism 4a shown in FIG. 11.

FIG. 26 is a view illustrating the process through which the bearing mechanism 4d is manufactured. FIG. 27 is a view showing the bearing mechanism 4d under the manufacturing process. In the manufacturing process of the bearing mechanism 4d shown in FIG. 26, step 4a is slightly different from that shown in FIG. 12. Further, step S5b illustrated in FIG. 21 is carried out instead of step S5a shown in FIG. 12, and steps S2, S6 and S7 are omitted.

First, the thrust member 45 is arranged on the bottom portion of the sleeve housing 43b (step S1), and a thermally curable adhesive agent is applied on the outer surfaces of the sleeve 42 and the seal member 44a. As shown in FIG. 27, the seal member 44a is inserted into the sleeve housing 43b after inserting the sleeve 42 and the shaft 41a thereinto (step S3). At this time, the lower end portion 411 of the shaft 41a comes into contact with the thrust member 45, and the shaft step portion 414 of the shaft 41a makes contact with the seal member 44a, whereby the position of the seal member 44a is set. Thereafter, the adhesive agent is heated and cured to ensure that the sleeve 42 and the seal member 44a are fixed within the sleeve housing 43b (step S4a).

The upper portion of the sleeve housing 43b is held by means of a holder unit not shown in the drawings. Referring to FIG. 27, the deformation target portion 434 is placed in the internal space of the pressing device 93 as shown in FIG. 24. In this state, the deformation target portion 434 is fitted to the pressing device 93 as indicated by double-dotted chain lines in FIG. 25 and is pressed toward the center axis J1. The deformation target portion 434 is subject to a plastic deformation so that the central portion of the bottom portion 432 is displaced downwardly away from the shaft 41a. As a result, the shaft 41a is also moved downwardly (step S5b), thus creating the axial gap 46 between the shaft step portion 414 of the shaft 41a and the seal member 44a.

As described above, in the same manner as the bearing mechanism 4c shown in FIG. 21, the sleeve housing 43b in the bearing mechanism 4d is directly deformed. Therefore, the axial gap 46 that allows the shaft 41a to move along the center axis J1 can be formed easily and cost-effectively. Further, presence of the step portion 433 prevents the plastic deformation from affecting the inner diameter of the sleeve 42. Provision of the gap 435 also prevents the plastic deformation from affecting the inner diameter of the sleeve 42. In addition, by forming the bottom portion 432 into a circular shape, stress concentration is avoided to allow the plastic deformation uniform in the circumferential direction, which in turn makes it possible to accurately form the axial gap 46.

FIG. 28 is a view showing a bearing mechanism 4e in accordance with another modified example of the second embodiment. As compared to the bearing mechanism 4c shown in FIG. 21, the bearing mechanism 4e differs only in the shape of the sleeve housing, and other parts are the same. As shown in FIG. 28, the sleeve housing 43c has a step portion 433a instead of the step portion 433 shown in FIG. 21. At the step portion 433a, the diameters of the outer and inner surfaces of the sleeve housing 43c are decreased with decreasing height. A gap 435 is provided between the step portion 433a and the sleeve 42. Further, a deformation target portion 434 whose diameter is gradually decreased with decreasing distance from the bottom portion 432 is formed below the step portion 433a.

FIG. 29 is a view showing the bearing mechanism 4e under the manufacturing process, which is the same as that of the bearing mechanism 4c. When the deformation target portion 434 is subject to plastic deformation, the upper portion of the sleeve housing 43c is held by a holder unit not shown in the drawings. The deformation target portion 434 is placed in the internal space of the pressing device 93 shown in FIG. 24 to be fitted to the pressing device 93 as shown in FIG. 28, and is pressed toward the center axis J1. Consequently, the deformation target portion 434 is subject to plastic deformation so that the central portion of the bottom portion 432 is displaced downwardly away from the shaft 41. As a result, the axial gap 46 is formed between the removal-preventing member 412 fixed to the shaft 41 and the sleeve 42.

In the same manner as above, it is also possible in the bearing mechanism 4e to easily and cost-effectively form the axial gap 46 that allows the shaft 41 to move along the center axis J1. Further, presence of the step portion 433a and the gap 435, individually and in combination, prevents the plastic deformation from affecting the inner diameter of the sleeve 42.

FIG. 30 is a view showing a bearing mechanism 4f in accordance with another modified example of the second embodiment. The step portion 433b of the sleeve housing 43d of the bearing mechanism 4f differs from the step portion 433 of the sleeve housing 43b shown in FIG. 21; other parts are the same as those of the bearing mechanism 4c shown in FIG. 21. The diameter of the outer surface of the sleeve housing 43d is decreased downwardly in the step portion 433b. The step portion 433b has at its inner peripheral portion an upwardly recessed annular groove portion (which forms an annular ridge portion within the sleeve housing 43d). A gap 435 is provided between the step portion 433b and the sleeve 42, and a deformation target portion 434 extends downwardly from the annular groove portion of the step portion 433b.

FIG. 31 is a view showing the bearing mechanism 4f under the manufacturing process, which is the same as that of the bearing mechanism 4c. When the deformation target portion 434 is subject to a plastic deformation, the pressing device 93 is placed to surround the outer surface of the deformation target portion 434 as shown in FIG. 31. Thereafter, the deformation target portion 434 is clamped and undergoes plastic deformation by the pressing device 93 as indicated by double-dotted chain lines in FIG. 30. In response, the central portion of the bottom portion 432 is pushed downwardly away from the shaft 41, thereby creating the axial gap 46 between the removal-preventing member 412 fixed to the shaft 41 and the sleeve 42.

In the same manner as above, it is also possible in the bearing mechanism 4f to easily and cost-effectively form the axial gap 46 that allows the shaft 41 to move along the center axis J1. Further, presence of the step portion 433b and the gap 435, individually and in combination, prevents the plastic deformation from affecting the inner diameter of the sleeve 42.

FIG. 32 is a view showing a bearing mechanism 4g in accordance with another modified example of the second embodiment. As compared to the bearing mechanism 4e shown in FIG. 28, the bearing mechanism 4g differs in the shape of the shaft, the thrust member 45 is omitted in the bearing mechanism 4g, and other parts are the same.

As can be seen in FIG. 32, the bearing mechanism 4g includes a shaft 41b which is substantially the same as that of the bearing mechanism 4b shown in FIG. 16. The shaft 41b has a substantially disk-like thrust plate 415 formed in the lower end portion thereof. A lubricant is filled in the sleeve housing 43c. As the shaft 41b is rotated, a dynamic pressure is generated in the radial gap between the outer surface of the shaft 41b and the inner surface of the sleeve 42 and in the thrust gaps between the thrust plate 415 and the lower surface 421 of the sleeve 42 and between the thrust plate 415 and inner bottom surface of the sleeve housing 43c. This allows the shaft 41 to rotate smoothly.

FIG. 33 is a view showing the bearing mechanism 4g under the manufacturing process. In the manufacturing process of the bearing mechanism 4g, steps S1 through S3 in the manufacturing process of the bearing mechanism 4 illustrated in FIG. 4 are performed first. Then, step S4b in FIG. 17 and step S5b in FIG. 22 are performed. In steps S1 through S3, the seal member 44 and the sleeve 42 that receives the shaft 41b are first fitted to the sleeve housing 43c as shown in FIG. 33. At this time, the lower surface of the thrust plate 415 of the shaft 41b (namely, the lower end of the shaft 41b) comes into contact with the inner bottom surface of the sleeve housing 43c, and the upper surface of the thrust plate 415 makes contact with the lower surface 421 of the sleeve 42. Then, the sleeve 42 and the seal member 44 are heated and adhesively fixed to the sleeve housing 43c (step S4b).

Next, the upper portion of the sleeve housing 43c is held by a holder unit not shown in the drawings. Referring to FIG. 33, the deformation target portion 434 is surrounded by the internal space of the pressing device 93 as in the case of FIG. 24. Thereafter, as indicated by double-dotted chain lines in FIG. 32, the deformation target portion 434 undergoes plastic deformation by the pressing device 93, so that the central portion of the bottom portion 432 is pushed downwardly away from the shaft 41b (step S5b). Thus, the axial gap 46 is formed between the thrust plate 415 of the shaft 41b and the sleeve 42.

As described above, use of the plastic deformation in the bearing mechanism 4g makes it possible to easily and cost-effectively form the axial gap 46 that allows the shaft 41 to move along the center axis J1. Further, as in the case of FIG. 28, provision of the step portion in the sleeve housing 43c and the gap between the step portion of the sleeve housing 43c and the sleeve 42, individually and in combination, prevents the plastic deformation from affecting the inner diameter of the sleeve 42. By forming the bottom portion 432 into a circular shape, stress concentration is prevented, and it is possible to perform the plastic deformation uniformly in the circumferential direction.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

In the bearing mechanism having the pivot bearing shown in FIG. 3 or 21, the material of which the thrust member 45 is made is not limited to the low-friction resin, but may be other materials. The central region of the upper surface of the thrust member 45 may be shaped as a plane or a concave partial sphere whose radius is greater than the radius of curvature of the lower end portion 411 in the shaft 41. Furthermore, the central region of the upper surface of the thrust member 45 may be shaped as an upwardly protruding partial sphere, in which case the lower end portion 411 of the shaft 41 is formed into a planar shape. That is, if one of the lower end portion 411 of the shaft 41 and the thrust member 45 has a convex surface, the other is formed into a concave shape or a planar shape.

The sleeve housing may be made of a material other than spring steel, such as a cold-rolled steel plate or steel strip (SPCC, SPCD, SPCE, etc.), an electro-galvanized steel plate (SECC, SECD, SECE, etc.), aluminum, aluminum alloy, copper, copper alloy, and magnetic or non-magnetic stainless steel (SUS303, SUS304, SUS420, etc.). The sleeve housing may be formed by a cutting work. The sleeve housing may be an injection-molded resin member. If the sleeve housing is made of a low-friction resin or the like, the thrust member 45 may be omitted, and the tip end of the shaft 41 may make direct contact with the inner bottom surface of the sleeve housing 43 to form a pivot bearing.

The order of assembling the bearing mechanism 4 shown in FIG. 4 is not limited to that of step S2 in which the shaft 41 is first inserted into the sleeve 42 and then the sleeve 42 is fitted to the sleeve housing 43. That is, it is also possible that the shaft 41 is first inserted into the sleeve housing 43 and then the sleeve 42 is fitted to the sleeve housing 43. If the circumstances permit, the order of assembling the bearing mechanism 4 may be properly changed. This holds true also in case of the bearing mechanisms of other embodiments.

Further, the task of tentatively fixing the sleeve 42 and the seal member 44 in step S4 is not limited to the light press-fitting. As an alternative example, an ultraviolet-curable and thermally curable adhesive agent may be applied between the sleeve 42 and the opening of the sleeve housing 43. In this case, ultraviolet rays are irradiated on the adhesive agent from outside to render the adhesive agent into a half-cured state, thereby tentatively fixing the sleeve 42 and the seal member 44. Thus, the sleeve 42 can be slid by being pressed during the assembling process. At the end of the assembling process, the adhesive agent existing between the sleeve 42 and the sleeve housing 43 is heated from outside to be cured, thereby fixing the sleeve 42. However, the task of tentatively fixing the sleeve 42 and the seal member 44 may be performed by other methods.

In the manufacture of the bearing mechanism 4c shown in FIG. 22, it is possible to employ a method in which the displacement amount of the shaft 41 is measured during the plastic deformation of step S5b and the pressing is performed until the displacement amount reaches a specified value. Further, the pressing device 93 is not limited to the one having the two pressing surfaces, but may have three or more pressing surfaces. In the manufacture of the bearing mechanism 4 shown in FIG. 3, the measurement of the displacement amount of the shaft 41 may be omitted when pressing the bottom portion 432 of the sleeve housing 43 by presetting the push-in amount of the pressing device 93. This may enable to provide the axial gap 46 more economically without sacrificing the accuracy.

Further, the annular member that determines the axial gap 46 is not limited to the sleeve 42 and the seal member 44, but may be other members fitted to the sleeve housing.

Further, the storage disk drive apparatus 1 is not limited to the hard disk drive, but may be an apparatus for driving an optical disk, a magneto-optical disk or the like. The bearing mechanism is suitable for use in a storage disk drive apparatus capable of performing one or both of the tasks of reading and writing data (i.e., the task of reading and/or writing data from and/or to a storage disk). Furthermore, the bearing mechanism may be used in a motor for other devices such as a laser printer and the like.

What is claimed is:

1. A method for manufacturing a bearing mechanism for use in a motor, comprising the steps of:
(a) setting a position of an annular member relative to a center axis by arranging the annular member within a substantially cylindrical bottom-closed sleeve housing, bringing one end portion of a shaft received in the annular member into contact with an inner bottom surface of the sleeve housing or with a thrust member disposed on the inner bottom surface, and bringing the annular member into contact with the shaft in a direction leading from an opening of the sleeve housing to a bottom portion of the sleeve housing;
(b) moving the annular member toward the opening of the sleeve housing through the shaft by externally pressing and elastically deforming the bottom portion of the sleeve housing;
(c) releasing the pressing of the bottom portion of the sleeve housing to restore the bottom portion to its original shape; and
(d) fixing the annular member to the sleeve housing.

2. The method of claim 1, wherein the end portion of the shaft and the inner bottom surface of the sleeve housing, or the end portion of the shaft and the thrust member form a pivot bearing that allows the shaft to rotate while in contact with the inner bottom surface of the housing or the thrust member.

3. The method of claim 1, wherein the displacement amount of the shaft is measured in the step (b), and the step (c) is performed when the displacement amount of the shaft reaches a specified value.

4. The method of claim 1, wherein the annular member includes a sleeve, and the shaft has a plate portion formed at or near the end portion of the shaft, and
wherein, in the step (a), the plate portion is allowed to make contact with an end surface of the sleeve.

5. The method of claim 4, wherein a dynamic thrust bearing is formed between an upper surface of the plate portion and the end surface of the sleeve, and/or between a lower surface of the plate portion and the inner bottom surface of the sleeve housing.

6. The method of claim 1, wherein the annular member includes a seal member arranged near the opening of the sleeve housing.

7. The method of claim 6, wherein the shaft is provided with a shaft step portion having a reduced outer diameter, and, in the step (a), the seal member and the shaft step portion make contact with each other.

8. The method of claim 6, wherein a lubricant is retained between the shaft and the annular member, an annular tapering gap whose width is gradually increased with increasing distance from the bottom portion is formed between the seal member and the shaft, and a boundary surface of the lubricant is formed within the tapering gap.

9. The method of claim 1, wherein, in the step (a), the annular member is tentatively fixed to the sleeve housing in a slidable manner by a half-cured adhesive agent or a light press-fitting.

10. The method of claim 1, wherein, in the step (b), the bottom portion of the sleeve housing is elastically deformed by causing a pressing device to press the center of the bottom portion.

11. The method of claim 1, wherein the sleeve housing is formed into a single continuously extending member.

12. An electric motor comprising:
a bearing mechanism manufactured by the method of claim 1;
a rotor unit, attached to the other end portion of the shaft, having a rotor magnet; and
a stator unit, to which the bearing mechanism is fixed, having a stator being opposite the rotor magnet.

13. A storage disk drive apparatus comprising:
the motor of claim 12 configured to rotate a storage disk;
an access unit configured to read and/or write data from and/or to the storage disk; and
a housing for receiving the motor and the access unit.

14. A method for manufacturing a bearing mechanism for use in a motor, comprising the steps of:
a) fixing an annular member to a substantially cylindrical bottom-closed sleeve housing while allowing the annular member and a shaft received in the annular member to be brought into contact with each other in a direction leading from an opening of the sleeve housing to a bottom portion of the sleeve housing by arranging the annular member within the sleeve housing and bringing one end portion of the shaft into contact with an inner bottom surface of the sleeve housing or with a thrust member disposed on the inner bottom surface; and
b) moving at least a central portion of the bottom portion away from the shaft by radially inwardly pressing an outer surface of a deformation target portion of the sleeve housing positioned axially between the inner bottom surface of the sleeve housing and the end surface of the annular member facing the inner bottom surface to perform a plastic deformation of the deformation target portion.

15. The method of claim 14, wherein the end portion of the shaft and the inner bottom surface of the sleeve housing, or the end portion of the shaft and the thrust member form a pivot bearing that allows the shaft to rotate while in contact with the inner bottom surface of the housing or the thrust member in the center axis.

16. The method of claim 14, wherein the sleeve housing is provided with a step portion, formed near the bottom portion, having a diameter decreasing with decreasing distance from the inner bottom surface, and
wherein the bottom portion is closer to the deformation target portion than to the step portion.

17. The method of claim 16, wherein the annular member includes a sleeve, and a gap is formed between an end surface of the sleeve and the step portion.

18. The method of claim 16, wherein the step portion includes a first portion near the bottom portion of the sleeve housing, and a second portion axially closer to the bottom portion of the sleeve housing than the first position, and
wherein a diameter of the step portion once decreases at the first portion, and then increases at the second portion to a length slightly smaller than a diameter of a side portion of the sleeve housing.

19. The method of claim 16, wherein the step portion is so shaped that diameters of outer and inner surfaces of the sleeve housing are decreased with decreasing distance from the bottom portion of the sleeve housing.

20. The method of claim 16, wherein a diameter of an outer surface of the sleeve housing is decreased with decreasing distance from the bottom portion of the sleeve housing, and the step portion has at its inner peripheral portion an annular groove portion recessed toward the opening of the sleeve housing.

21. The method of claim 14, wherein the bottom portion of the sleeve housing has a circular shape.

22. The method of claim 14, wherein, in the step (b), a plastic deformation of the deformation target portion is performed by clamping the outer surface of the deformation target portion with a working tool having a semicircular concave portion whose diameter is slightly smaller than that of the outer surface of the deformation target portion.

23. The method of claim 14, wherein the annular member includes a sleeve, a plate portion is provided near the end portion of shaft, and the plate portion makes contact with an end surface of the sleeve in the step (a).

24. The method of claim 14, wherein the annular member includes a seal member arranged closer to the opening of the sleeve housing than to the bottom portion of the sleeve housing.

25. The method of claim 24, wherein the shaft is provided with a shaft step portion having a reduced outer diameter, and the seal member and the shaft step portion make contact with each other in the step (a).

26. The method of claim 24, wherein a lubricant is retained between the shaft and the annular member, an annular tapering gap whose width is gradually increased with increasing distance from the bottom portion is formed between the seal member and the shaft, and a boundary surface of the lubricant is formed within the tapering gap.

27. The method of claim 14, wherein the sleeve housing is formed into a single continuously united member.

28. An electric motor comprising:
a bearing mechanism manufactured by the method of claim 14;
a rotor unit, attached to the other end portion of the shaft, having a rotor magnet; and
a stator unit, to which the bearing mechanism is fixed, having a stator being opposite the rotor magnet.

29. A storage disk drive apparatus comprising:
the motor of claim 28 configured to rotate a storage disk;
an access unit configured to read and/or write data from and/or to the storage disk; and
a housing that receives the motor and the access unit.
